(19) United States
(12) Patent Application Publication
(10) Pub. No.: US 2007/0130368 A1
(43) Pub. Date: Jun. 7, 2007

(54) Method and apparatus for identifying potential recipients

(75) Inventors: Miquel Martin, Heidelberg (DE); Ernoe Peter Kovacs, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/607,897

(22) Filed: Dec. 4, 2006

(30) Foreign Application Priority Data
Dec. 5, 2005 (DE) 10 2005 058 110.2

(51) Int. Cl. G06F 15/16

(52) U.S. Cl. 709/245

(57) ABSTRACT

A method for identifying potential recipients of a message wherein the message comprises a text message and wherein the message is in electronic form is—regarding a possibly simple usability and user-friendliness—designed and further developed in such a way that the content of the message undergoes a text analysis and based on the result of the text analysis a potential recipient or a group of potential recipients are identified from a list of recipients.

### BACKGROUND OF THE INVENTION

1. Field of the Invention

The present invention relates to a method for identifying potential recipients of a message, wherein the message comprises basically a text message and wherein the message is in electronic form.

2. Description of the Related Art

Written messages are common and important tools for human communication. Besides printed messages in form of letters, faxes or similar messages, messages in electronic form have been increasing in number. Only to give some examples, electronic mail (e-mail), SMS (short message service), instant massaging or fora in the Internet should be mentioned. Every message is created by an author and transmitted to one or more recipients. For sending, the respective correct identifier of the recipient(s) is necessary. For an e-mail, the correct e-mail address has to be inserted, for an SMS it has to be the corresponding phone number.

In order to simplify the insertion of the respective identifiers, phone and/or address books are commonly kept. Here, the identifiers are entered once in a list, a database or comparable means. When retrieving the stored information, only the requested entry needs to be selected from the phone/address book. If there are many entries in the phone/address book, searching for the correct recipient identifier can become time-consuming.

For this reason, many of the currently available e-mail programs offer an automatic completion of the e-mail address. The user has to insert the first characters of the email address into the address field and receives from the program address suggestions that start with the indicated series of characters. The problem here is that the user has to know rather exactly the respective address.

Attributed to the different strategies by which e-mail addresses are created, this possibly becomes difficult. If, additionally, such a particular e-mail address is very seldom utilized by the user, this automatic completion becomes practically useless, because the user will not remember the address. In addition, such automatic completions are error prone in the sense that a user tends to overlook words if the displayed entry is similar to the expected entry. If you are in a hurry, it can happen that an e-mail is unintentionally sent to a wrong recipient.

### SUMMARY OF THE INVENTION

Hence, the present invention is based on the task to design and further develop a method of the above-mentioned kind for identifying potential recipients in such a way that a possibly easy usability, user-friendliness and error detection when selecting one or more recipients can be achieved.

According to the invention, the task mentioned above is solved by a method showing the characteristics of claim 1. According to this, such a method is characterized in that the content of the message undergoes a text analysis and based on the result of the text analysis a potential recipient or a group of potential recipients are identified from a list of recipients.

According to the invention, it has first been recognized that every message varies in its style and subject depending on the respective recipient and that this information can be considered when identifying potential recipients. Business correspondence is rather likely to be in a more formal style and will rather refer to work-specific contents. Moreover, the correspondence addressing a business partner will be more formal than a message to a colleague. Such differences also occur in private life.

According to the invention, it has been recognized that this information can be considered for identifying potential recipients. To do so, the content of the message undergoes a text analysis and the result of the text analysis is used to identify one or more potential recipients. For this end, recipients or a group of recipients are correspondingly selected from a list of recipients.

A list of recipients has to be understood here as a generic term. A list can relate to only a listing of individual contact information, but it can also comprise phone books, address books, address data banks, or other means for storing contact identifiers. In the same way, the terms “address” or “identifier” can refer to any possibility apt to unambiguously identify a recipient. This can comprise, for example, a telephone number, a mobile number, an e-mail address, an identifier in an internet forum, an instant massaging identifier or the like.

In an advantageous way, the text analysis extracts the individual features. Features can here refer to a great variety of characteristics of a message. In this sense, the appearance of specific words can be searched. If a message contains, for example, a remark regarding a meeting, this strongly indicates a message in a business context. If, in addition, a rather informal style is used, then it is very likely that it refers to a meeting with a colleague. Moreover, it can be searched for specific salutation or closing phrases. Other properties that characterize the corresponding recipient can be used as features as well. For example, the maximum or average length of sentences can be checked.

In private life, in general shorter sentences will be formulated than in business life. Moreover, for example, the maximum or average word length, a specific construction of a message, the usage of a signature, the number of word-wrappings or other features can be important.

All features can depend on the corresponding author of the message. Each user will satisfy certain approved conventions when writing a message, but he will still show specific personal characteristics. Hence, besides commonly used features, the text analysis could refer also to user-specific features.

These features extracted from the analyzed message can then be compared to and combined with features of potential recipients. By doing so, a classification can be performed and in the optimum case the recipient can be identified who is most probably the recipient of the analyzed message. The extraction and/or classification of features can be performed by a multitude of analysis algorithms or classification algorithms.

Preferably, machine-learning algorithms are applied. Only to give an example, but not restricting the method to this, the usage of a neural network, a support-vector machine, an MFU (Most Frequently Used) algorithm or a Bayesian classifier should be mentioned. See, for example, the followings:
(1) O. De Vel, A. Anderson, M. Corney, and G. Mohay “Mining Email Content for Author Identification Forensics” SIGMOD Record, Vol. 30, No. 4, pp. 55-64, December 2001;
(2) Paul Graham, “A Plan for Spam” (http://www.paulgraham.com/spam.html), August 2002;
(3) Bryan Klimt, Yiming Yang, “Introducing the Enron Corpus” First Conference on Email and Anti-Spam (CEAS), Proceedings July 2004;
(4) I. Rish, “An empirical study of the Naïve Bayes classifier” 17th International Joint Conference on Artificial Intelligence, August 2001; and

(5) R. B. Segal, J. O. Kephart “MailCat: An Intelligent Assistant for Organizing E-Mail” Proceedings of the National Conference on Artificial Intelligence, 1999.

Depending on the available computing power, number of features to extract, requested precision of the identified potential recipients or other ancillary conditions a correspondingly appropriate algorithm can be selected. Possibly also the application of several algorithms can be envisioned which could be changed according to the operational situation.

When using a Bayesian classifier, it is wise to use a naive Bayesian classifier for better computability reasons. In contrast to the classic Bayesian classifier, in case of a naive Bayesian classifier the individual features are not regarded as being dependent from each other, a fact due to which the conditional probability in the computation formula of the Bayesian classifier is split into individual conditional probabilities depending only on the corresponding feature. Even though this assumption does seldom apply in reality, the naive Bayesian classifier in practice often achieves good results. This is the case it the individual features do not correlate too much. Also, when considering messages, the individual text features will not be completely independent from one another. The features are sufficiently uncorrelated, though, to justify the application of a naive Bayesian classifier.

All known analysis and/or classification algorithms have in common that they refer to knowledge resulting from already performed and preferably verified mutual correlations of messages and recipients. Preferably, this knowledge is generated by training. For this end, individual messages written by the user, are used for training, by analyzing the text, and matching it to the recipients that the user manually selected.

Since the training itself needs a rather high number of messages in order to achieve good results of classification, the system can also be trained with messages that are already written by the user and hence also correlated to one or more recipients of the list of recipients. Because of the usage of the newly written messages, the knowledge grows continuously, which results in the fact that the analysis and/or classification based on such knowledge provide better results, and adapt to the changing habits of the user.

In particular with regard to a possibly changing communication behavior towards a recipient, newer knowledge can be weighted more than older knowledge. For example, a more personal relationship can be established with a business partner, which will result in a more informal structure of the messages. By these means, a changed behavior of the user can be respected. Newer knowledge gains a stronger impact on the identification of potential recipients.

In order to further reduce the efforts when building up knowledge, different features that will occur with almost all authors of messages can be incorporated in a basic knowledge. Such a basic knowledge can be used as pre-training or directly inserted on the running system.

In order to further increase efficiency of the first usage of the method according to the invention, the user could be invited to give some more details about the recipient when inserting a recipient in a list of recipients. This could, for example, comprise the categorization of the respective recipient (business, colleague, private, friends, family etc.). In addition, the user can be requested to classify already existing entries in the list of recipients in a similar way. By doing so, a first selection can be performed by a simple analysis of the message and many recipients can be excluded at a very early stage.

By these means the most probable recipient of a message can be identified. On the other hand, these recipients can be identified who are rather improbably the recipients of the analyzed message.

The recipient(s) who are identified in this way can then be displayed and suggested to a user. The suggested recipients could be sorted and displayed according to their probability. Improbable recipients could be excluded from the list.

This could be used in such a way that when inserting the recipient of a message the correctness of the insertion is checked. The text analysis can determine the probability with which the message is actually addressed to the indicated recipient. On the other hand, the recipient(s) indicated by the user could be compared to the identified recipients. By these means it can also be determined with which probability the correct recipient has been indicated. If the probability is too low, the user could in both cases be informed in an appropriate manner or the recipient could be exchanged by a more probable recipient.

Regarding a further example of an embodiment, the identified recipients could be used also for an automatic completion of the contact data of the recipient. After the user has written a message and inserts the contact data, the recipient could be suggested, who is the most probable recipient of the message, and who probably starts with a combination of characters indicated by the user. By these means it can efficiently be avoided to send a message to a wrong recipient due to insertion of recipient by automatic completion.

In another embodiment of the present invention, after having written the message the user could be indicated a group of recipients that contains all potential recipients.

The user can define a threshold stating the degree that the features extracted from the text have to match the features of the recipients. All recipients achieving a higher matching than this threshold could be displayed as potential members of the group of recipients. By these means it is possible to incorporate recipients into the group whom the user would have forgotten initially.

In another embodiment of this invention, the system could simply monitor users that consistently receive messages about the same topics, and conclude that a set of individuals is in fact a topic group. This information could then be made available to the user or other applications, which can employ them in any way needed, such as, to better user applications that use information about working groups.

In another example of an embodiment, the method according to the invention can be applied in the context of internet fora or other environments in which huge numbers of messages have to be managed. The messages coming in at a server could be analyzed regarding their content. Based on the result of the analysis those recipients could be identified who often retrieve similar messages. These messages could accordingly be marked as being interesting for those users. The knowledge about preferred contents could also be updated continuously.

In all examples of an embodiment, the user could be offered the possibility to erase intentionally individual identifiers from the identified recipients. In the context of internet fora or similar environments, the own recipient identifier could be erased from the identified recipients. By such erasing, the knowledge to perform the analysis and/or classification could be updated simultaneously.

Now, there are several options of how to design and to further develop the teaching of the present invention in an advantageous way. For this purpose, it must be referred to the claims subordinate to claim 1 on the one hand and to the following explanation of a preferred example of an embodiment of the method of the invention together with the figure on the other hand.

In connection with the explanation of the preferred example of an embodiment and the figure, generally preferred designs and further developments of the teaching will also be explained.

### BRIEF DESCRIPTION OF THE DRAWINGS

FIG. 1 is a a flow chart showing an implementation of the method according to the invention;

FIG. 2A is a flow chart showing the application for an implementation of the method according to the invention in connection with a naive Bayesian classifier;

FIG. 2B is a flow chart showing the training for an implementation of the method according to the invention in connection with a naive Bayesian classifier; and

FIG. 3 is a block diagram showing an information processing apparatus in which the method according to the invention is implemented.

### DESCRIPTION OF THE PREFERRED EMBODIMENTS

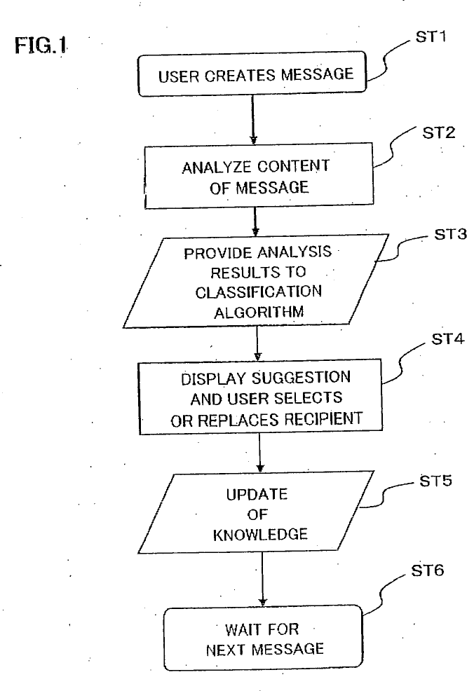

FIG. 1 shows a flow chart of an implementation of the method according to the invention. The individual processes are in general independent from the applied algorithm for performing the extraction and/or classification of features. First of all, the user creates a message in step 1. The content of the message is analyzed in step 2 and subsequently in step 3, the results of the analysis are fed to a classification algorithm. Finally, in step 4 a suggestion to the user is generated who selects one of the suggested recipients or replaces a recipient not contained in the suggestions. A correlation of the analyzed message and the user, which is performed in such a way, is used to update the knowledge required for classification. For this end, in step 5 an update of knowledge is started. A connection between the extracted features and the selected recipient is established and combined with the gathered information about the corresponding recipient. After that, further messages are waited for in step 6.

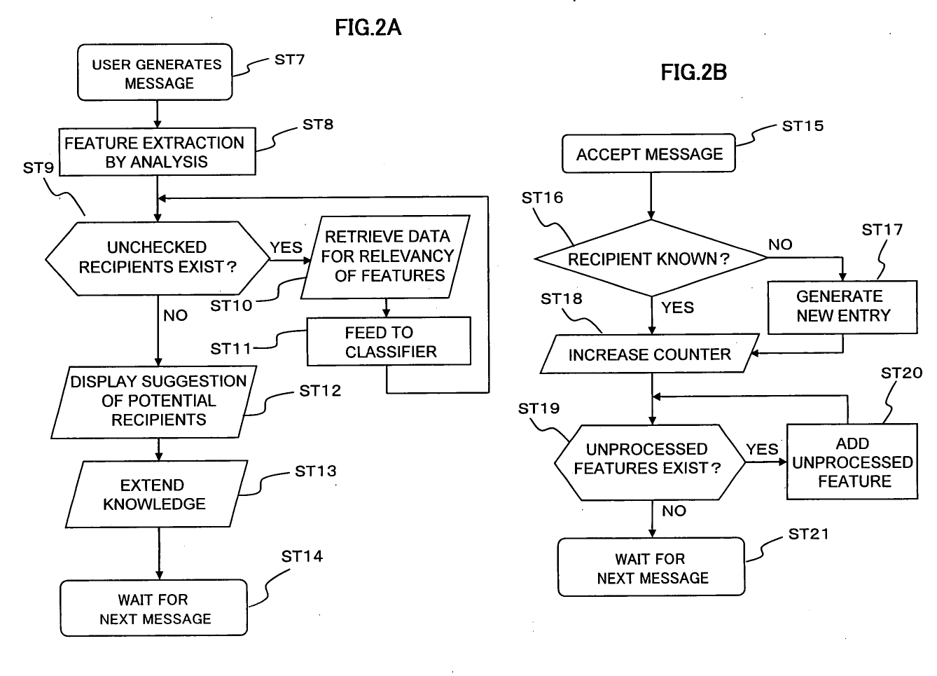

FIGS. 2A and 2B show two flow charts using the method according to the invention in connection with a naive Bayesian classifier which can be derived from a Bayesian classifier. A Bayesian classifier is in principle based on the Bayesian theorem that relates conditional probabilities. In the given example the probability can be computed with which a message Mᵢ is addressed for a recipient Rⱼ. This probability is conditional because the features Tₐ, T_{b}, T_{c} , . . . occur in the message Mᵢ. The conditional probability is hence computed by:

$$P ( {M}_{i} ⋐ {R}_{j} \vert {T}_{a} , {T}_{b} , {T}_{c } , K ) = \frac{P ( {T}_{a} , {T}_{b} , {T}_{c} , K \vert {M}_{i} ⋐ {R}_{j} ) \cdot P ( {M}_{i} ⋐ {R}_{j} )}{P ( {T}_{a } , {T}_{b} , {T}_{c} , K )}$$

P(Tₐ, T_{b}, T_{c}, . . . |Mᵢ⊂Rⱼ) computes the probability that the features Tₐ, T_{b}, T_{c}, . . . are contained in a message addressed to the recipient Rⱼ. In general, there is a dependency between the features Tₐ, T_{b}, T_{c}, . . . . In case of the naive Bayesian classifier it is assumed though that the individual features can occur independently from each other in the message. The conditional probability P(Tₐ, T_{b}, T_{c}, . . . |Mᵢ⊂Rⱼ) can be replaced by the product of the conditional probabilities for the individual features. Since the denominator P(Tₐ, T_{b}, T_{c}, . . . ) in the formula given above is independent from the recipient, this part can be ignored when determining the relevancy of the message Mᵢ for the recipient Rⱼ. Hence, the following term has to be computed:
P(Tₐ|Mᵢ⊂Rⱼ)·P(T_{b}|Mᵢ⊂Rⱼ)·K·P(Mᵢ⊂Rⱼ)
The individual factors are the probabilities with which the individual features Tₐ, T_{b}, T_{c}, . . . in the message Mᵢ to the recipient Rⱼ occur.

FIG. 2A shows an implementation of the method according to the invention for the application of this naive Bayesian classifier. Here, the common process for the application of the method is depicted in a flow chart. First of all, the user generates a message (step 7). After that, the features of the message are extracted by an analysis algorithm in step 8. If the features Tₐ, T_{b}, T_{c}, . . . were selected well, at least some of the features will be contained in the message.

In the following, the individual recipients stored in the list of potential recipients are analyzed regarding the relevancy of the individual features and based on this the relevancy of the message for the recipient is computed. In step 9 it is first of all checked whether there are unchecked recipients contained in the list of recipients. If so, in step 10 the data for the relevancy of the features is retrieved and in step 11 fed to a naive Bayesian classifier. After this, the processing of step 9 continues. Only if all the recipients of the list of recipients are processed, the loop is left and in step 12 a suggestion to the user is generated. This suggestion indicates one or more potential recipients that should be considered as recipients according to the analysis and classification.

Finally, all the computed data is used for extending the knowledge and the combination of features and correlated recipient(s) is combined with already existing knowledge (step 13). After that, further messages can be processed (step 14). FIG. 2b shows a flow chart for performing a training procedure. This procedure can be applied for the first building up of knowledge, as well as for updating the knowledge. In step 15, a message is accepted. With step 16 it is checked whether the list of recipients already contains the recipient of the message and whether the recipient is hence known. If the recipient is unknown, a new entry is generated (step 17). In both cases (recipient known or recipient unknown) a counter for the messages sent to the recipient is increased afterwards (step 18). In the following, the individual features contained in the message are processed and categorized as relevant for the recipient. For this end, step 19 first checks whether there are still unprocessed features. If so, an unprocessed feature is added in step 20 to the recipient and the processing is continued with step 19. Only after having processed all the features in this way, the loop is left. After that, the program flow is finished and further messages can be processed.

One possible example follows: When the user types in the following message:

“Dear John, I am attaching the requested reports for our quality control test next Monday. I'll meet you directly at the testing facilities. Best regards, Andrew”.

The text analysis could retreive the words “John”, “quality”, “control” and “meet” and propose (through classification) John@foo.com as a possible recipient, since the user (Andrew) usually discusses quality control issues with John. Likewise, the formality of the message, the word “meet” and the mention of a week day, “Monday” could propose Andrew's boss or his secretary to the proposed recipients.

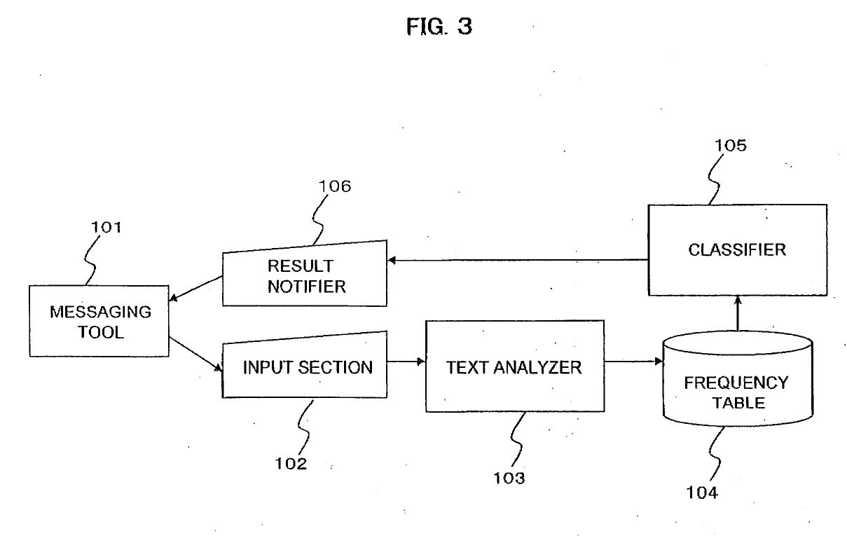

As shown in FIG. 3, an information processing apparatus is provided with a messaging tool 101 that feeds the text of the message through an input section 102 by which a user can perform message input, selection or replacement of a potential recipient and the like. If the apparatus is expected to not only predict recipients, but also correct or suggest based on user input, the messaging tool 101 may also provide the tentative list of recipients as sent by the user. An input message is then passed to a text analysis module 103 which stores the frequency of apparition of the message features in relation to the selected recipients into a frequency table 104. Classification is then performed by a classifier 105 that generates a potential recipient list, which is sent back to the messaging tool 101 through the result notifier 106. By the user selecting or replacing a potential recipient, the frequency table 104 is updated accordingly. Note that in the case of using a mechanism other than a Bayesian Classifier, the message sequence could be different, and some of the blocks would be implemented differently, removed, or new blocks added.

Finally, it is particularly important to point out that the completely arbitrarily chosen examples of an embodiment from above only serve as illustration of the teaching as according to the invention, but that they do by no means restrict the latter to the given examples of an embodiment.

1. A method for identifying potential recipients of a message wherein the message comprises basically a text message and wherein the message is in electronic form, wherein the content of the message undergoes a text analysis and based on the result of the text analysis a potential recipient or a group of potential recipients are identified from a list of recipients.

2. The method according to claim 1, wherein individual features of the message are extracted by the text analysis.

3. The method according to claim 2, wherein the extracted features are compared to features of recipients of the list of recipients and a classification is performed.

4. The method according to claim 1, wherein for extraction and/or classification of features a machine learning algorithm is used, wherein the machine learning algorithm is one selected from a group including a neural network, a support vector machine, an MFU (Most Frequently Used) algorithm and a Bayesian classifier.

5. The method according to claim 4, wherein the Bayesian classifier is simplified to a naive Bayesian classifier.

6. The method according to claim 1, wherein the most probable recipient(s) and/or the most improbable recipient(s) is/are identified.

7. The method according to claim 1, wherein for the analysis and/or classification, knowledge from previously performed and verified correlations of messages and recipients are used.

8. The method according to claim 7, wherein the knowledge is built up by a training procedure.

9. The method according to claim 7, wherein the knowledge is completed and/or updated by the choice and/or insertion and/or removal of a recipient of a message.

10. The method according to claim 8, wherein the knowledge is completed and/or updated by the choice and/or insertion and/or removal of a recipient of a message.

11. The method according to claim 7, wherein more recent knowledge is weighted more than older knowledge and hence has more impact on the identification of potential recipients.

12. The method according to claim 1, wherein more detailed data about the recipients and/or the preferences set by a user are used for identifying potential recipients.

13. The method according to claim 12, wherein the more detailed data comprises information about recipients in the list of recipients.

14. The method according to claim 1, wherein the identified recipient(s) are indicated as suggestion to a user.

15. The method according to claim 14, wherein the suggested identified recipients are shown sorted according to their identified probability.

16. The method according to claim 1, wherein the identified recipient(s) is/are used for automatic completion of the contact data of a recipient.

17. The method according to claim 1, wherein based on the identified recipient(s) a group of recipients is generated.

18. The method according to claim 17, wherein the groups of recipients are shared with the user or other applications for instance, for usage with group related tools.

19. The method according to claim 1, wherein the recipient(s) indicated by the user is/are compared to the identified recipients.

20. The method according to claim 19, wherein recipients as indicated by the user are corrected according to their identified probability, or in that the user is indicated the deviation in an appropriate way.

21. An apparatus for identifying potential recipients of a message, comprising:
an analyzer for analyzing the content of the message; and
a classifier for classifying the message based on the result of the analysis to identify a potential recipient or a group of potential recipients from a list of recipients.
